(19) United States
(12) Patent Application Publication
(10) Pub. No.: US 2016/0102488 A1
(43) Pub. Date: Apr. 14, 2016

(54) IMAGE FORMING APPARATUS

(71) Applicant: CANON KABUSHIKI KAISHA, Tokyo (JP)

(72) Inventors: Shigeo Doi, Toride-shi (JP); Tadahisa Sugiyama, Matsudo-shi (JP)

(21) Appl. No.: 14/876,170

(22) Filed: Oct. 6, 2015

(30) Foreign Application Priority Data
Oct. 14, 2014 (JP) 2014-209736

(51) Int. Cl. E05F 1/10; E05F 3/16; E05D 15/30; E05D 7/06; E05D 11/08; E05F 5/06; E05F 3/20

(52) U.S. Cl. CPC E05F 1/10; E05F 5/06; E05F 3/16; E05F 3/20; E05D 7/06; E05D 11/08; E05D 15/30

(57) ABSTRACT

A loading portion applying a load to a movement of an opening/closing unit include an arm portion engaged with the rotating member to cause the rotating member to be rotated according to the movement of the opening/closing unit, the arm portion includes a first arm member that includes a first engagement portion to be engaged with the rotating member and a second arm member that includes a second engagement portion to be engaged with the rotating member, and the first arm member move relatively to the second arm member in conjunction with an opening/closing operation of the opening/closing unit.

### BACKGROUND OF THE INVENTION

1. Field of the Invention

The present invention relates to an image forming apparatus which includes an opening/closing unit provided to be freely opened or closed.

2. Description of the Related Art

In recent years, there are various proposals for enhancing operability of portions that a user operates for the purpose of improving a quality of an image forming apparatus. Among them, in a so-called door portion which is a part of the outer case and provided to handle trouble such as jam occurrence, an impact buffering portion is provided to buffer an impact generated at a time when the door is opened up to a predetermined opening position and stopped by a stopper member. There is a proposal to prevent a damage caused by an impact generated when a main body of the image forming apparatus or the door is opened as well as to give a good operability to the user.

Specifically, the following proposal is made for the impact buffering portion for such an opening/closing operation of the door.

First, an opening/closing mechanism of a cover of the image forming apparatus disclosed in Japanese Patent Laid-Open No. 2006-83551 is provided with an arc groove having a gear portion disposed inside the vicinity of the rotation center, and includes a gear which is meshed with the gear portion inside the groove and can be freely rotated. In the gear, a rotary damper is included in a rotating axial direction, and a control force (load) is applied during the operation of opening or closing the cover. In this way, an impact generated when the opening/closing operation of the cover is ended is buffered by applying the control force.

Next, in Japanese Patent Laid-Open No. 2007-279274, a load is applied to the opening/closing door by a rack and an oil damper which control the rotation of a pinion. In addition, the pinion and the rack are configured to be separated in an operation where the damper effect is not required.

On the other hand, there is an image forming apparatus in which a plurality of opening angles is set in one door. As the above-mentioned plurality of opening angles, there are generally set an opening angle for trouble handling performed by the user, and an opening angle for regular replacement of components or replacement of units which is performed by a maintenance manager represented by a so-called service man.

In other words, as a main trouble handling performed by the user, a work of removing a jam sheet caused by a jam occurrence or other remaining sheets is exemplified. In this case, the door may be opened only by an amount sufficient for removing the jam sheet. However, in a case where the maintenance manager replaces the components or the units in the regular replacement using the opening portion of the same door, a switching portion is configured to perform switching to open the door larger than a case where the jam recovery is performed in order to make sure of works smoothly without causing damage in the replacing object.

In Japanese Patent Laid-Open No. 2003-241466, there is provided a regulation portion which regulates the door to be opened at a plurality of opening angles according to a usage such as an opening position for the jam recovery performed by the user and an opening position for the maintenance performed by the manager typically represented by a service man. Furthermore, in a case where the door is opened up to the opening position for the jam recovery among a plurality of opening positions, a load is applied to the movement of the door before the door reaches the opening position, and an impact generated when the door is stopped is buffered. However, it is desired to minimize the apparatus for applying the load to the movement of the door.

### SUMMARY OF THE INVENTION

In an image forming apparatus provided with an opening/closing unit, it is desirable to minimize an apparatus which applies a load to a movement of the opening/closing unit.

In order to achieve the above object, an image forming apparatus comprising: a main body of the image forming apparatus; an opening/closing unit that is provided to be opened or closed with respect to the main body; and a loading portion that applies a load on a movement of the opening/closing unit, wherein the loading portion includes a rotating member, a damper unit that applies a load to a rotation of the rotating member, and an arm portion that is engaged with the rotating member to cause the rotating member to be rotated according to the movement of the opening/closing unit, wherein a load of the damper unit is applied to the moving opening/closing unit by engaging the arm portion with the rotating member, wherein the arm portion includes a first arm member that includes a first engagement portion to be engaged with the rotating member, and a second arm member that includes a second engagement portion to be engaged with the rotating member when the opening/closing unit is opened larger than a position of the opening/closing unit where the rotating member and the first arm member are engaged, and is provided to be movable with respect to the first arm member, and wherein the first arm member and second arm member move relatively to each other in conjunction with an opening/closing operation of the opening/closing unit.

Further features of the present invention will become apparent from the following description of exemplary embodiments with reference to the attached drawings.

### BRIEF DESCRIPTION OF THE DRAWINGS

FIG. 1 is a cross-sectional view schematically illustrating an image forming apparatus which includes an opening/closing unit.

FIG. 2 is a diagram schematically illustrating the image forming apparatus which includes the opening/closing unit.

FIG. 3 is a diagram schematically illustrating the image forming apparatus which includes the opening/closing unit.

FIG. 4 is a diagram schematically illustrating an engagement state between a pinion and a rack where a rotary damper is attached.

FIG. 5 is a diagram schematically illustrating a configuration for maintaining the engagement state between the pinion and the rack.

FIG. 6 is a diagram for schematically illustrating a configuration of the rack having a gear portion.

FIG. 7 is a diagram schematically illustrating a state where a door is closed.

FIG. 8 is a diagram schematically illustrating an opened state where the door is opened up to a first opening position.

FIG. 9 is a diagram schematically illustrating a state where the door is opened up to a second opening position.

FIG. 10 is a diagram schematically illustrating a configuration for making the rack folded.

FIG. 11 is a diagram schematically illustrating a state where the door is closed up to a jam recovery position.

FIG. 12 is a diagram schematically illustrating a state where the rack begins to be folded during the door is closed.

FIG. 13 is a diagram schematically illustrating a state where the rack is folded during the door is closed.

FIG. 14 is a diagram schematically illustrating a state where the door is closed.

### DESCRIPTION OF THE EMBODIMENTS

An image forming apparatus according to embodiments of the invention will be described in detail as an example with reference to the drawings. Further, dimensions, materials, and relative positions of components of the image forming apparatus described in the following embodiments are not intended to limit a scope of the invention if not otherwise specified.

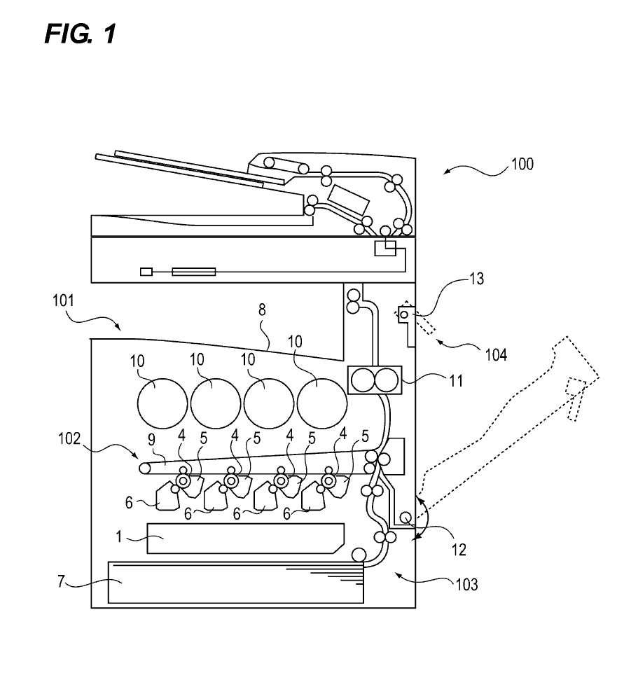

First, the image forming apparatus which includes an opening/closing unit according to the present embodiment will be described using FIG. 1. FIG. 1 is a cross-sectional view schematically illustrating a configuration of the image forming apparatus which includes the opening/closing unit of this embodiment.

As illustrated in FIG. 1, an image forming apparatus 100 serves to perform image formation using an image forming portion 102 to form an image on a sheet sent by a sheet feeding device 103 stored in a main body 101.

The image forming portion 102 includes a drum unit 5, a developing unit 6, and an intermediate transfer belt unit 9. The drum unit 5 includes a photosensitive drum 4 which forms an electrostatic latent image by an exposure device 1 where a light beam is emitted based on image data. The developing unit 6 supplies the toner sent by a toner bottle 10 onto the photosensitive drum 4 so as to develop the electrostatic latent image. The intermediate transfer belt unit 9 transfers the toner image formed on the photosensitive drum 4. The drum unit 5, the developing unit 6, and the intermediate transfer belt unit 9 are configured to be detachably attachable to the main body 101 for the purpose of the jam recovery in the main body 101 and maintenance/replacement of inner mechanisms.

A sheet conveyance path is configured such that the sheet is fed from the sheet feeding device 103, an image is formed on the sheet through the image forming portion 102, a door unit 104, and a fixing device 11 which permanently fixes the toner transferred on the sheet, and the sheet is discharged to a discharge tray 8 on the outside of the main body 101.

In the image forming apparatus of this embodiment, the drum unit 5 and the developing unit 6 in the image forming portion 102, the toner bottle 10, and a sheet cassette 7 are inserted or removed from the front surface side of the main body 101. On the other hand, the fixing device 11 and the intermediate transfer belt unit 9 in the image forming portion 102 are inserted or removed by opening the door unit 104 of a side surface of the main body 101. In addition, the removing work of a jammed sheet is mainly performed by opening the door unit 104. Further, the front surface of the image forming apparatus is a surface of the apparatus when the image forming apparatus illustrated in FIG. 1 is viewed in front of the apparatus. Regarding the side surface, the surface on the right side when the image forming apparatus illustrated in FIG. 1 is viewed from the front side is the right surface, and the surface on the left side is the left surface.

In addition, the door unit 104 is an opening/closing unit which is provided to be freely opened or closed with respect to the main body 101 and provided with a plurality of opening positions different in opening angles. The door unit 104 is provided in one side surface (herein, the right surface where the sheet conveyance path is provided) of the main body 101, axially supported by a shaft 12 disposed in the lower portion of the main body 101, and provided to be freely rotated about the shaft 12. Furthermore, a holding portion 13 is provided in the door unit 104 to help an operator to freely open or close the door unit. At the time of the jam recovery or the maintenance of the inner mechanisms, the operator holds the holding portion 13 and turns the door unit 104 in the right direction with respect to the main body 101 to be rotated about the shaft 12, and thus can expose the inner portion of the main body for the access thereto.

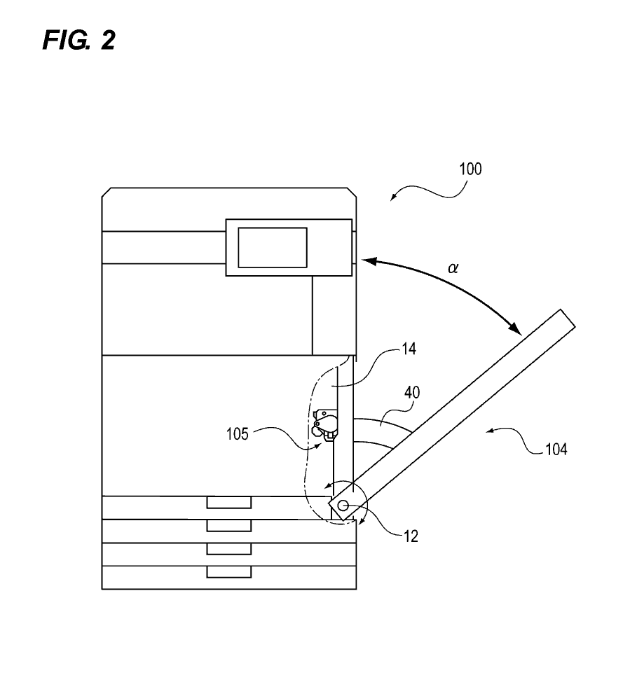

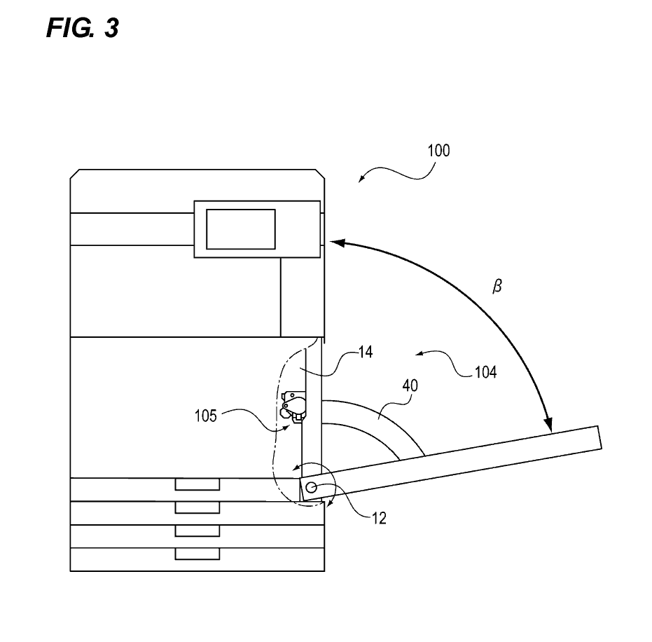

FIGS. 2 and 3 are schematic diagrams of the image forming apparatus 100 when the door unit 104 is opened, in which a cross-sectional view of a portion taken in the vicinity of a damper mechanism in the main body is illustrated.

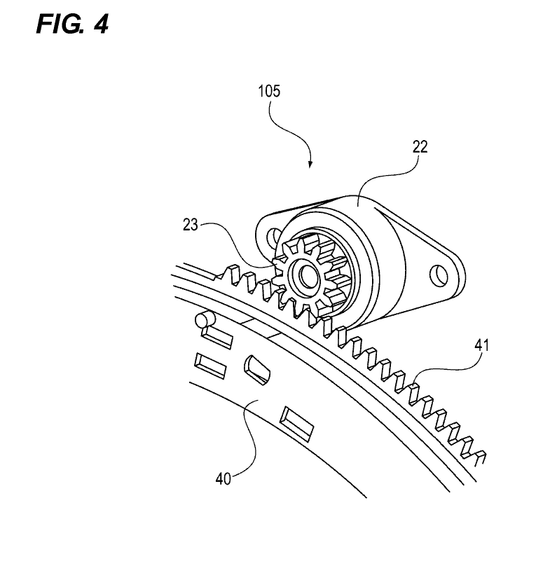

In the door unit 104, a rack 40 is provided as an arm portion which serves as an impact buffering portion to be described later. The rack 40 provided in the door unit 104 moves along the rotation of the door unit 104 about the shaft 12. At this time, the rack 40 is configured to move in the engagement state with a pinion 23 (serving as a rotating gear) to which a rotary damper 22 is attached as illustrated in FIG. 4 in a damper unit 105 disposed in a main frame 14 (the component of the main body 101), thereby performing a damper function.

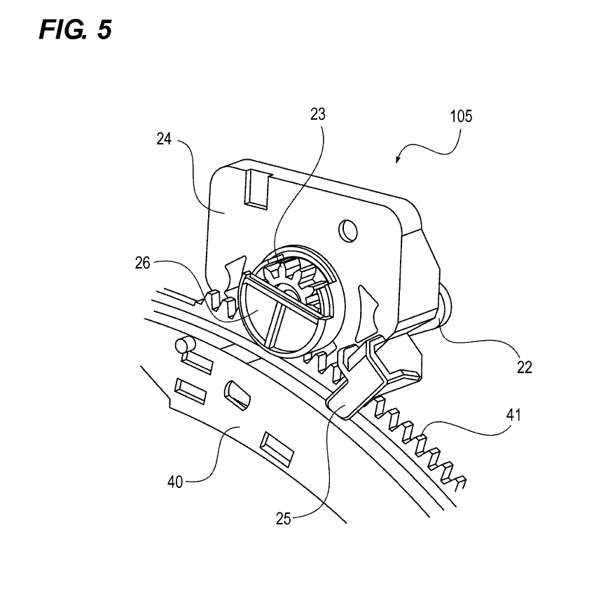

In addition, FIGS. 4 and 5 illustrate a detailed configuration of the damper unit 105. FIGS. 4 and 5 are perspective views illustrating the damper unit 105 disposed in the main body and a part of the rack 40 engaged with the pinion 23 of the damper unit 105.

As illustrated in FIGS. 4 and 5, the damper unit 105 and the rack 40 form an impact buffering portion which buffers an impact on at least one opening position of an opening/closing unit having a plurality of opening positions at different opening angles. The damper unit 105 serving as a loading portion which applies a load on the movement of the door unit 104 includes the rotary damper 22 attached to the pinion 23 serving as a rotating member having a gear portion on the outer periphery, and a damper holder 24 serving to attach these components to the main frame 14.

In the damper holder 24, a rack disengagement prevention member 25 and a rack thrust displacement prevention member 26 are provided in order to stabilize the engagement between the pinion 23 and a gear portion 41 of the rack 40. With this configuration, the rack 40 moves in a rotating axial direction of the pinion 23, and prevents the engagement between the pinion 23 and the gear portion 41 of the rack 40 from being released.

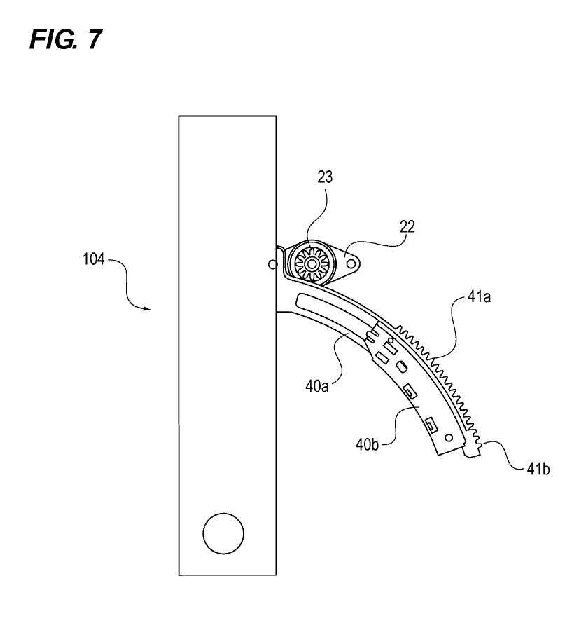

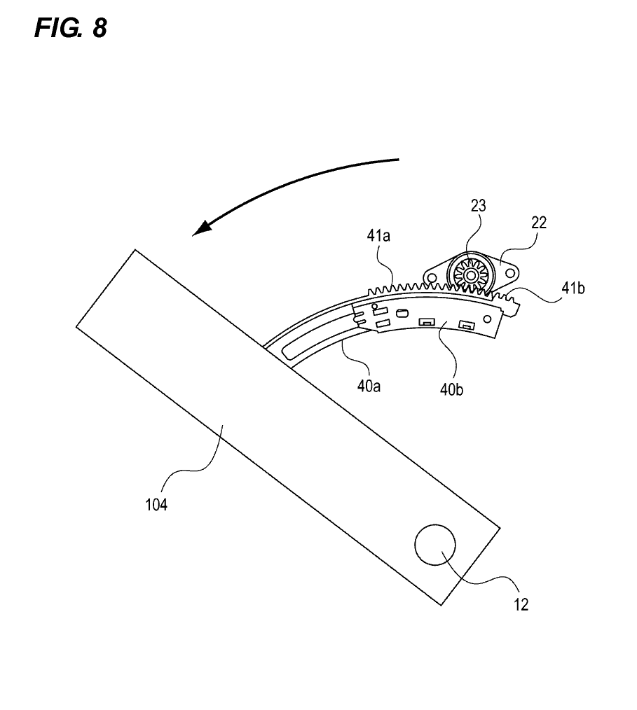

The rack of the image forming apparatus in this embodiment will be specifically described using FIGS. 7 and 8.

As illustrated in FIGS. 7 and 8, the rack 40 includes a fixed portion (a first arm member) 40a which is fixed to the door unit 104, and a slide portion (a second arm member) 40b which is attached to freely slide within a specified range in an arc direction with respect to the fixed portion 40a. A fixed portion gear 41a serving as a first engagement portion to be meshed with the pinion 23 is provided in a part of the fixed portion 40a serving as a rack member. A slide gear 41b serving as a second engagement portion to be meshed with the pinion 23 is also provided in a part of the slide portion 40b. In other words, in the rack 40, the gear portion 41 serving as an engagement portion to be meshed with the pinion 23 includes the fixed portion gear 41a which is provided in a part of the fixed portion 40a, and the slide gear 41b which is provided in a part of the slide portion 40b. The slide portion 40b serving as the slide member is extended in an arrangement direction of teeth of the fixed portion gear 41a.

The fixed portion gear 41a is disposed to be meshed with the pinion 23 from just before a first opening position at an angle of α illustrated in FIG. 2 from a state where the door unit 104 illustrated in FIG. 7 is closed, and so as to be meshed within a range where the door unit 104 is opened up to the first opening position at the angle of α. FIG. 8 illustrates the state where the door unit 104 is opened up to the first opening position at the angle of α. In other words, in the image forming apparatus of this embodiment, the fixed portion gear 41a is set to be meshed with the pinion 23 within a predetermined range corresponding to the first opening position. Herein, the opening angle of α=45° (not particularly limited) of the first opening position is mainly assumed to be the opening angle of the door unit 104 when a user performs the jam recovery. Then, the fixed portion gear 41a is set to be meshed with the pinion 23 from just before a position at the angle α of about 20°. Then, the door unit 104 is opened up to the angle of a using a stopper function (not illustrated) to buffer the impact caused when being stopped at the first opening position using the damper function of the damper unit 105. One of the purposes of buffering the impact is to satisfy the user with the comfortability during the operation. Another purpose of buffering the impact is to avoid that the door itself may be broken by the impact or the components in the main body (specifically, the main frame 14) may be deformed when the user releases his/her own hand in the middle of opening the door, or when the door is opened with a force exceeding an expected load.

In addition, in the state where the door unit 104 is about closed, the fixed portion gear 41a is set not to be meshed with the pinion 23. The reason is to avoid that an opening operation is not loaded on the user, and to make the operation easy. In the state where the door unit 104 begins to be opened, the weight of the door itself is little affected in the opening direction. Therefore, when the fixed portion gear 41a is meshed with the pinion 23 in the state where the door unit 104 begins to be opened, a rotary load of the rotary damper 22 is dominant and becomes a load on the user who performs the opening operation. In order to avoid such a situation, in the state where the door unit 104 is about closed, the fixed portion gear 41a is set not to be meshed with the pinion 23. Furthermore, while being also caused by a balance between the weight of the door itself and the rotary load of the rotary damper 22, in a case where the rotary load of the damper is applied when the door is slightly opened, the door unit 104 may be stopped although the door unit is not at a predetermined opening position yet when the user releases his/her own hand. Therefore, the above configuration is considered as an object from the viewpoint of making operability easy to understand, and also may be for the purpose of avoiding such a situation.

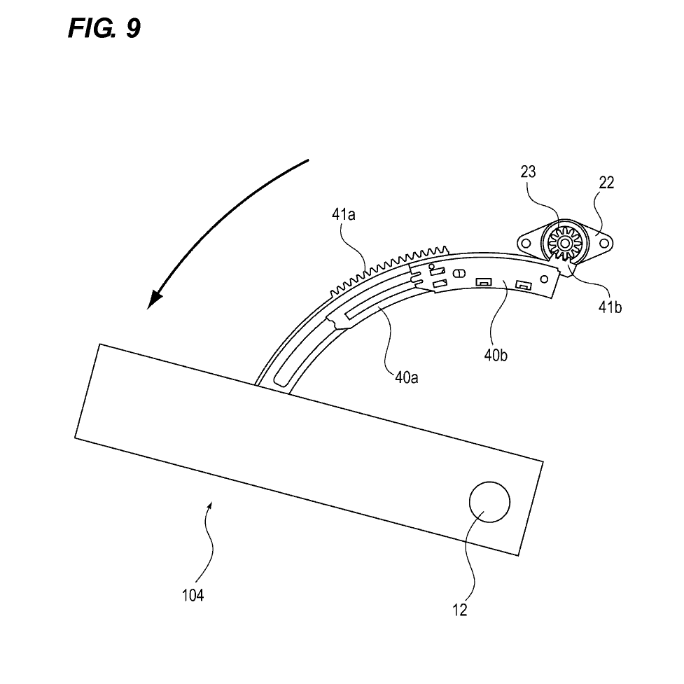

The slide gear 41b is disposed at a position where the slide gear is continuously connected to the fixed portion gear 41a in a state where the rack 40 is fully folded as illustrated in FIG. 7. In the image forming apparatus of this embodiment, the number of teeth of the slide gear 41b is three (not particularly limited). In a case where the stopper function (not illustrated) is released and the door unit 104 is opened further at the time of maintenance, the slide gear 41b is meshed with the pinion 23. Therefore, the pinion 23 is not rotated by the rotary load of the rotary damper 22 and the movement of the slide portion 40b is restricted. Then, the fixed portion 40a having the fixed portion gear 41a which is released from the meshing with the pinion 23 slides in a circumferential direction relatively to the slide portion 40b of which the movement is restricted. Therefore, the rack 40 enters an extending state as illustrated in FIG. 9. FIG. 9 illustrates a state where the door unit 104 is opened up to a second opening position at an angle of β larger than the opening angle α. The amount of sliding of the fixed portion 40a with respect to the slide portion 40b is appropriate to an extent that the slide gear 41b is kept in meshing with the pinion 23 in a state where the door unit 104 illustrated in FIG. 2 is opened from the angle α up to the angle β as illustrated in FIG. 3. In the image forming apparatus of this embodiment, since the meshing area of the fixed portion gear 41a is set up to about 50° at the opening angle β=75° (not particularly limited) of the second opening position, the remaining 25°+[Margin] becomes the sliding amount of the fixed portion 40a with respect to the slide portion 40b.

In addition, as described above, when the door unit 104 is opened or closed, the purpose of extending or folding the rack 40 in conjunction with the opening/closing operation is as follows.

First, in a case where the rack 40 is not extended or folded, for example, a long rack having the length at the time when the rack 40 is extended is employed, there is a need to prepare a space for storing the long rack when the door unit 104 is closed. In the image forming apparatus of this embodiment, since the damper unit 105 is disposed in the front side of the apparatus, the position of the long rack in the state where the door is closed enters a movement area of the sheet cassette which is inserted or removed with respect to the front of the main body and the drum unit, or the developing unit on the most right side. Therefore, in this case, when a sheet is replenished to the sheet cassette, or when the drum unit or the developing unit is maintained, the door on the right side should be opened on purpose.

In addition, on the contrary, when the rack is set only to be the length corresponding to the first opening position at the angle of α illustrated in FIG. 2 (a state where there is no slide portion 40b), the meshing operation between the pinion and the rack is necessary when the door is closed from the second opening position at the angle of β illustrated in FIG. 3 having a large opening angle. At this time, since the initial position where the pinion is meshed with the rack at the beginning is a position farthest away from the position for the fixing to the door, the rack itself is bent in an axial direction of the pinion if the rack does not have a sufficient rigidity, so that it is considered that the gears are not possible to be easily meshed. In addition, while being also caused by the attaching position of the rack, it may be not easy work for the operator to support the door with his/her hand in order to make the gears meshed in the main body.

In order to cope with these problems, as described above, when the door unit 104 is opened or closed, the rack 40 is extended or folded in conjunction with the opening/closing operation. According to this embodiment, as described above, since the rack 40 is extended or folded in conjunction with the opening/closing operation of the door unit 104, the retreating space for the rack 40 in the apparatus can be made small while keeping the engagement between the pinion 23 and the gear portion 41 of the rack 40.

Among the configurations of the image forming apparatus described above, in a case where the rotary load is applied on both sides in the rotation direction of the rotary damper, the operation of the door unit 104 from the state where the door is opened up to the angle of β to the closed state is sequentially performed as illustrated in FIGS. 9, 8, and 7 in this order. Therefore, a detailed operation sequence will not be given herein.

However, in the rotary damper, an operating force for closing the door unit 104 is in a state where the rotary load of the rotary damper is added to the weight of the door. Therefore, the operability is not suitable.

Then, the image forming apparatus of this embodiment employs the rotary damper 22 which is provided with a one-way function in order to apply the rotary load only at the time of opening the door unit 104. Making a simple description, the load is applied when the pinion 23 is rotated in the right direction in FIGS. 7, 8, and 9, but on the contrary there is applied almost no load when the rotation is made in the left direction. In other words, the load is applied to the rotary damper when the door unit is opened, but no load is applied to the rotary damper when the door unit is closed.

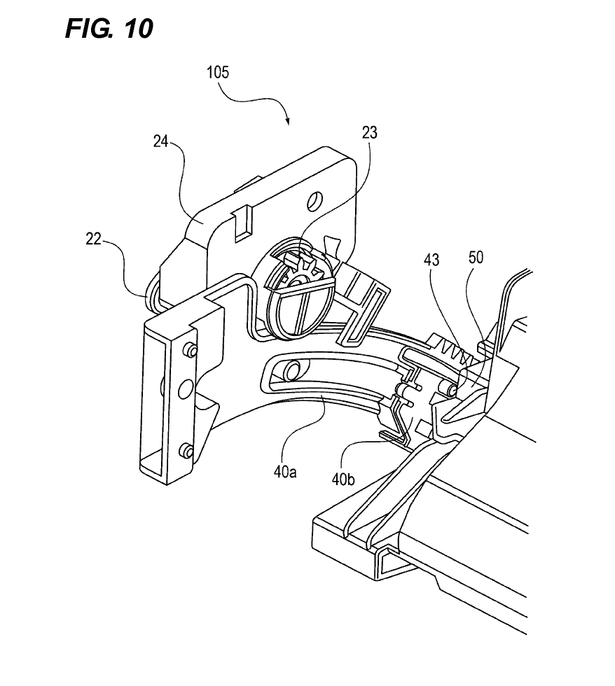

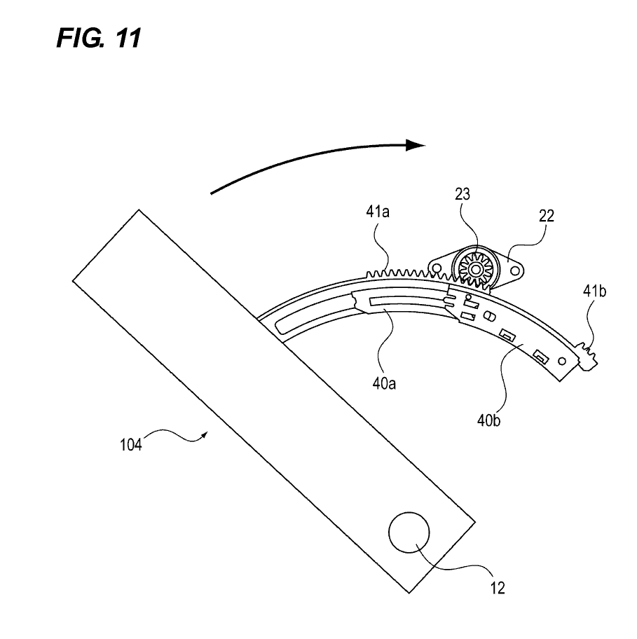

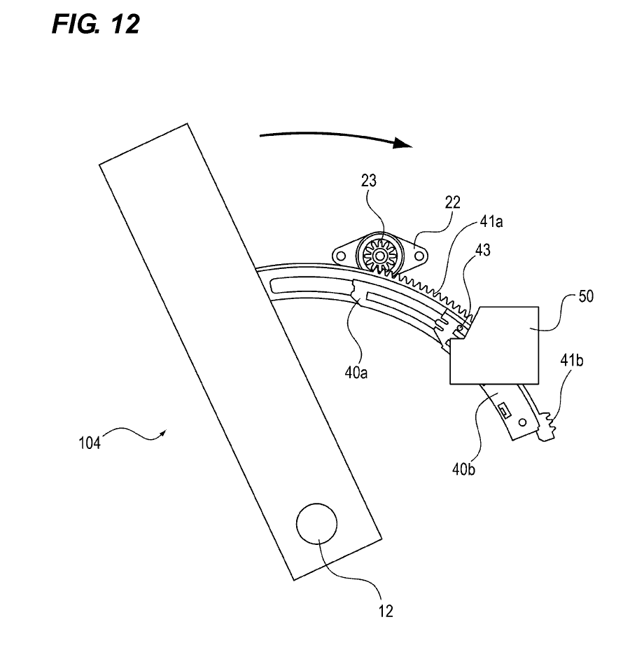

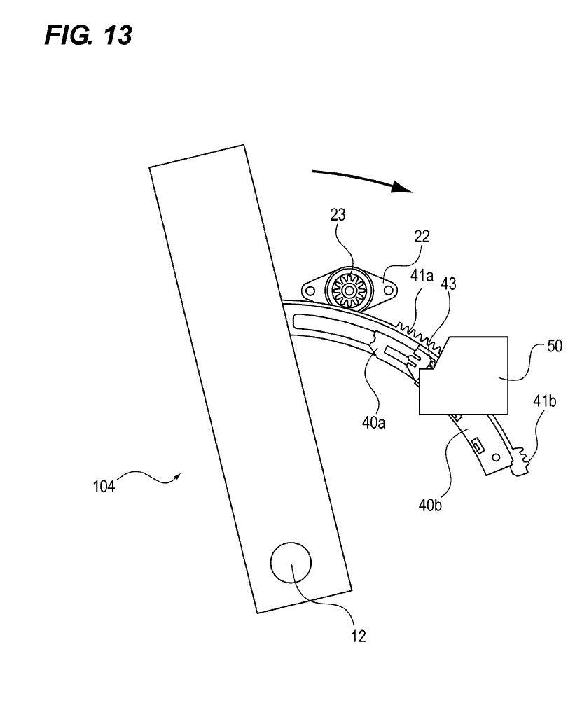

When the above configuration is employed, a force is applied to the slide gear 41b in the operation from a state where the door unit 104 is opened up to the second opening position of the angle of β to the closed state, but the pinion 23 is rotated under almost no load. Therefore, as illustrated in FIG. 11, the slide portion 40b is also rotated in the same direction together with the fixed portion 40a. The rack 40 in this extended state is necessarily shrunk again to the position where the slide gear 41b and the fixed portion gear 41a are continuously connected as illustrated in FIG. 7. Then, as illustrated in FIG. 10, a projection 43 is provided in a part of the slide portion 40b, and a stopper member 50 is provided to make the projection 43 abut on the main body. With this configuration, the projection 43 of the slide portion 40b during the operation of closing the door abuts on the stopper member 50 as illustrated in FIG. 12, so that the slide portion 40b does not move from the abutting position. Therefore, when the door unit 104 is more closed, the fixed portion 40a moves relatively to the slide portion 40b and the rack 40 enters a shrunk state as illustrated in FIG. 13, and finally can be stored compact as illustrated in FIG. 7.

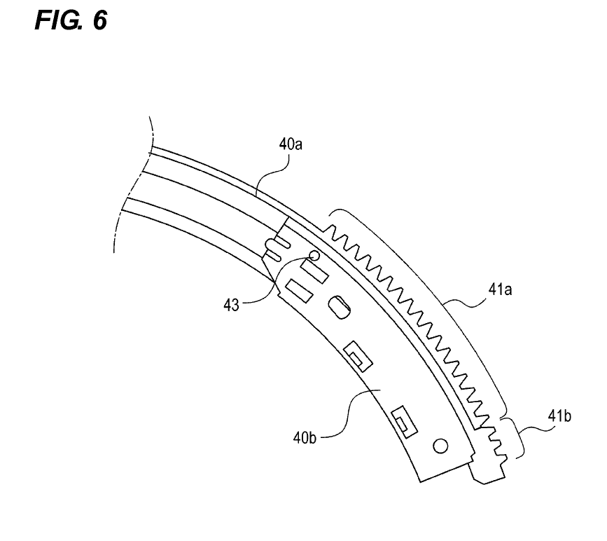

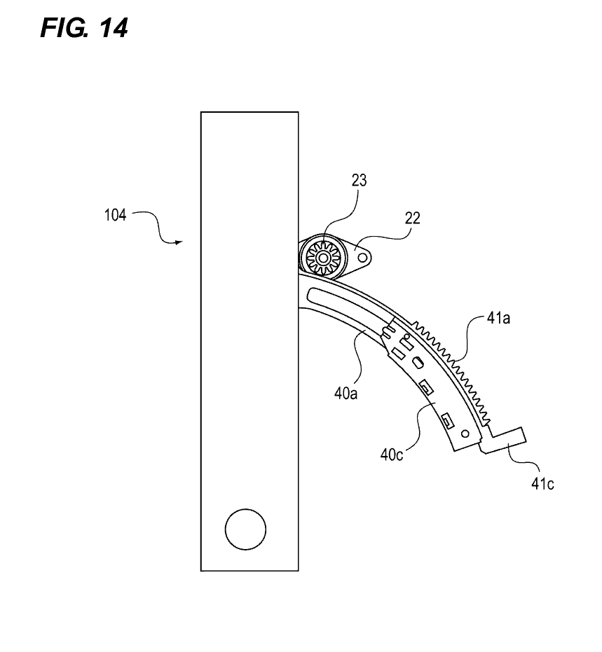

In the configuration described hitherto, the configuration that the slide gear 41b is provided as the slide portion 40b illustrated in FIG. 6 has been exemplarily described as a transfer portion which makes the rack transferred to an extended state, but the invention is not limited thereto. For example, as illustrated in FIG. 14, even when a hooking member 41c may be provided in the slide portion 40b as an engagement portion instead of the slide gear, the same effect can be obtained.

In this embodiment, the reason why the slide portion 40b illustrated in FIG. 6 is employed is that the pinion 23 and the rack 40 can be easily meshed at the second opening position at the time of maintenance illustrated in FIGS. 3 and 9 only by sliding the slide portion 40b. Specifically, in a case where the door unit 104 is assembled in the main body 101, a case where the components in the door unit 104 are attached or detached for the replacement, or a case where the door unit 104 is replaced, the pinion 23 and the rack 40 can be meshed only by sliding the slide portion.

Furthermore, in the above-mentioned embodiment, the rack 40 is attached to the door unit 104, and the damper unit 105 containing the pinion 23 meshed with the rack 40 is attached to the main frame 14, but the invention is not limited thereto. For example, the damper unit 105 may be attached to the door unit 104, and the rack 40 may be attached to the main frame 14 as long as basic configurations of the rack 40 and the damper unit 105 are similar to each other. Even in this case, the same effect can be obtained.

In addition, in the above-mentioned embodiment, the gear portion meshed with the pinion is exemplified as an engagement portion of the arm portion, but the invention is not limited thereto. For example, there may be employed other configurations such as a configuration in which the rotating member is configured by a rubber roller, an arc engagement portion to be engaged with the outer surface of the rubber roller with pressure is provided in the arm portion.

In addition, in the above-mentioned embodiment, the description has been made about the configuration in which the impact buffering portion of the door unit having the opening for attaching or detaching the intermediate transfer belt unit, but the invention is not limited thereto. Even when the invention is applied to the impact buffering portion of the opening/closing unit having an opening for attaching or detaching other units such as the sheet cassette, the drum unit, and the developing unit, the same effect can be obtained.

In addition, in the above-mentioned embodiment, the printer is exemplified as the image forming apparatus, but the invention is not limited thereto. For example, other image forming apparatuses such as a copying machine and a facsimile apparatus, or a multifunction peripheral in which these functions are combined may be applied. In addition, the invention is not limited to the image forming apparatus using an intermediate transfer member, but may be applied to an image forming apparatus which uses a recording material bearing member and transfers toner images of respective colors sequentially and in an overlapping manner onto the recording material carried in the recording material bearing member. The same effect can be obtained by applying the invention to the impact buffering portion of the opening/closing unit having an opening for attaching or detaching the unit in these image forming apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-209736, filed Oct. 14, 2014, which is hereby incorporated by reference herein in its entirety.

What is claimed is:

1. An image forming apparatus comprising:
a main body of the image forming apparatus;
an opening/closing unit that is provided to be opened or closed with respect to the main body; and
a loading portion that applies a load on a movement of the opening/closing unit,
wherein the loading portion includes
a rotating member,
a damper unit that applies a load to a rotation of the rotating member, and
an arm portion that is engaged with the rotating member to cause the rotating member to be rotated according to the movement of the opening/closing unit,
wherein a load of the damper unit is applied to the moving opening/closing unit by engaging the arm portion with the rotating member,
wherein the arm portion includes
a first arm member that includes a first engagement portion to be engaged with the rotating member, and
a second arm member that includes a second engagement portion to be engaged with the rotating member when the opening/closing unit is opened larger than a position of the opening/closing unit where the rotating member and the first arm member are engaged, and is provided to be movable with respect to the first arm member, and
wherein the first arm member and second arm member move relatively to each other in conjunction with an opening/closing operation of the opening/closing unit.

2. The image forming apparatus according to claim 1,
wherein an impact of the opening/closing unit is buffered by a load of the damper unit by an engagement between the first engagement portion and the rotating member according to an opening operation of the opening/closing unit,
the arm portion is extended according to the opening operation of the opening/closing unit by making the first arm member having the first engagement portion moves relatively to the second arm member having the second engagement portion by in a state in that the engagement between the first engagement portion and the rotating member is released and the second engagement portion and the rotating member are engaged.

3. The image forming apparatus according to claim 2,
wherein the damper unit applies a load to a rotation in a direction of opening the opening/closing unit of the rotating member.

4. The image forming apparatus according to claim 1,
wherein a projection is provided in the second arm member, and a stopper member used to abut on the projection is provided in the main body, and
wherein the second arm member having the projection stops moving by making the projection abut on the stopper member and the first arm member moves relatively to the second arm member according to a closing operation of the opening/closing unit, thereby the arm portion is shrunk.

5. The image forming apparatus according to claim 4,
wherein the damper unit does not apply a load to a rotation in a direction of closing the opening/closing unit of the rotating member.

6. The image forming apparatus according to claim 1,
wherein the first arm member is provided in the opening/closing unit, and the damper unit is provided in the main body, and
wherein the first and the second arm members move according to an opening operation of the opening/closing unit, an impact of the opening/closing unit is buffered by a load of the damper unit by an engagement between the first engagement portion and the rotating member, and
the first arm member having the first engagement portion moves relatively to the second arm member having the second engagement portion according to the opening operation of the opening/closing unit in a state that releasing the engagement between the first engagement portion and the rotating member and the second engagement portion and the rotating member are engaged.

7. The image forming apparatus according to claim 1,
wherein the damper unit includes a prevention member to prevent an engagement between the rotating member and the engagement portion from being released in a rotating axial direction.

8. The image forming apparatus according to claim 1,
wherein the rotating member is a gear, and the first arm member is a rack member having a gear portion that is meshed with the gear in a predetermined range corresponding to the opening position.

9. The image forming apparatus according to claim 1,
wherein the second arm member includes a surface that is extended in an arrangement direction of a gear portion of the rack member.

10. The image forming apparatus according to claim 1,
wherein the first arm member moves relatively to the second arm member according to an operation of closing the opening/closing unit, thereby the arm portion is shrunk.

11. An image forming apparatus comprising:
a main body of the image forming apparatus;
an opening/closing unit that is opened or closed with respect to the main body;
a gear that is rotated;
a damper unit that applies a load to a rotation of the gear;
a rack member that includes a gear portion to be meshed with the gear and rotates the gear according to a movement of the opening/closing unit; and
a slide member that is provided in the rack member to be movable,
wherein the rack member and the slide member move relatively to each other in an arrangement direction of teeth of the gear portion according to the movement of the opening/closing unit.

12. The image forming apparatus according to claim 11,
wherein the slide member includes an engagement portion to be engaged with the gear, and
wherein the rack member and the slide member move relatively to each other such that the teeth of the gear portion and the engagement portion are separated according to an opening operation of the opening/closing unit in a state where the gear and the engagement portion are engaged.

13. The image forming apparatus according to claim 12,
wherein the damper unit applies a load to a rotation of the gear when the opening/closing unit is opened.

14. The image forming apparatus according to claim 11, further comprising
a stopper member that abuts on the slide member,
wherein the movement of the slide member is stopped by making the slide member abut on the stopper member according to a closing operation of the opening/closing unit, and the slide member and the rack member move relatively to each other.

15. The image forming apparatus according to claim 14,
wherein the damper unit does not apply a load to a rotation of the gear when the opening/closing unit is closed.

16. The image forming apparatus according to claim 11,
wherein the rack member is provided in the opening/closing unit, and
wherein the damper unit is provided in the main body.

17. The image forming apparatus according to claim 11,
wherein the damper unit includes a prevention member to prevent an engagement between the gear and the gear portion of the rack member from being released in a rotating axial direction of the gear.

18. The image forming apparatus according to claim 11,
wherein the slide member is extended in the arrangement direction of teeth of the gear portion.

19. The image forming apparatus according to claim 11,
wherein the slide member includes an engagement portion to be engaged with the gear, and
wherein the rack member and the slide member move relatively to each other such that the gear portion of the rack member and the engagement portion are close according to an operation of closing the opening/closing unit.
